(19) United States
(12) Patent Application Publication
(10) Pub. No.: US 2011/0093533 A1
(43) Pub. Date: Apr. 21, 2011

(54) GENERATING SITE MAPS

(76) Inventors: Rupinder Kataria, Darlinghurst (AU); Maximilian Ibel, Pfaeffikon (CH); Gangjiang Li, Shanghai (CN); Narayanan Shivakumar, Bellevue, WA (US)

(21) Appl. No.: 12/988,078

(22) PCT Filed: Apr. 17, 2008
(86) PCT No.: PCT/CN2008/000786

§ 371 Date: Dec. 8, 2010

(51) Int. Cl. G06F 15/173; G06F 15/16

(52) U.S. Cl. 709/203; 709/224

(57) ABSTRACT

Methods, systems, and apparatus, including computer program products, for generating sitemaps. The method includes scanning network traffic between a server and one or more clients requesting resources from the server, the network traffic including resource request messages from the one or more clients and resources served by the server in response to the resource request messages. The method also includes automatically extracting data from the traffic served by the server to the one or more clients, the extracted data including one or more Uniform Resource Locators that identify the resources served by the server to the one or more clients. The method automatically generates a sitemap from the extracted data, and stores the sitemap in a computer-readable memory.

### BACKGROUND

This specification relates to sitemaps.

The Sitemap protocol allows webmasters to inform search engines about Uniform Resource Locators (URLs) of a host (e.g., a website) that are available for crawling by a search engine.

A conventional sitemap, as described in the Sitemap protocol, is an Extensible Markup Language (XML) document that lists URLs of a website. In addition, a conventional sitemap can include metadata associated with the URLs. For example, the metadata can include information such as the last time the resource identified by a URL was modified, the frequency that the resource changes, and the priority of the resource relative to other resources on the host. The Sitemap protocol is described under the heading Sitemaps XML Format at http://www.sitemaps.org/protocol.php.

Conventional tools that can generate sitemaps (e.g., Google Sitemap Generator) require webmaster interaction to identify resources to be included in a sitemap.

### SUMMARY

This specification describes technologies relating to sitemap generation.

In general, one aspect of the subject matter described in this specification can be embodied in methods that include the actions of scanning network traffic between a server and one or more clients requesting resources from the server, the network traffic including resource request messages from the one or more clients and resources served by the server in response to the resource request messages; automatically extracting data from the traffic served by the server to the one or more clients, the extracted data including one or more Uniform Resource Locators that identify the resources served by the server to the one or more clients; automatically generating a sitemap from the extracted data; and storing the sitemap in a computer-readable memory. Other embodiments of this aspect include corresponding systems, apparatus, and computer program products.

These and other embodiments can optionally include one or more of the following features. The sitemap includes the one or more Uniform Resource Locators. The sitemap further includes at least one of a last modified date, a change frequency, or a priority for the one or more Uniform Resource Locators. The method includes automatically notifying a search engine that the sitemap has been generated or modified. The method includes, according to webmaster preferences, modifying the extracted data before automatically generating the sitemap.

In general, another aspect of the subject matter described in this specification can be embodied in a system that includes a server that includes a computer and one or more clients in data communication with the server. The server performs the actions of scanning network traffic between a server and one or more clients requesting resources from the server, the network traffic including resource request messages from the one or more clients and resources served by the server in response to the resource request messages. The server also performs the actions of automatically extracting data from the traffic served by the server to the one or more clients, the extracted data including one or more Uniform Resource Locators that identify the resources served by the server to the one or more clients. The server performs the actions to automatically generate a sitemap from the extracted data, and store the sitemap in a computer-readable memory.

Implementations of this aspect can optionally include one or more of the following features. The sitemap includes the one or more Uniform Resource Locators. The sitemap further includes at least one of a last modified date, a change frequency, or a priority for the one or more Uniform Resource Locators. The system further performs the action of automatically notifying a search engine that the sitemap has been generated or modified. The server performs the action of, according to webmaster preferences, modifying the extracted data before automatically generating the sitemap. The actions of scanning and extracting can be performed by plug-in software installed in a web server program running on the server. The actions of scanning and extracting can also be performed by software installed in a network layer of the server.

Particular embodiments of the subject matter described in this specification can be implemented to realize one or more of the following advantages. Automatically generating sitemaps reduces how much webmaster interaction is required to generate and maintain sitemaps. In addition to saving time, reducing interaction can increase the reliability of sitemaps by reducing the likelihood of webmaster mistakes. In addition, automatically generating sitemaps can increase the coverage of sitemaps by capturing both dynamic and static content served by a server.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example of generation and submission of a sitemap.

FIG. 2 is a block diagram illustrating an example of generation of a sitemap.

FIG. 3 is a flow chart showing an example process for automatically generating a sitemap.

Like reference numbers and designations in the various drawings indicate like elements.

### DETAILED DESCRIPTION

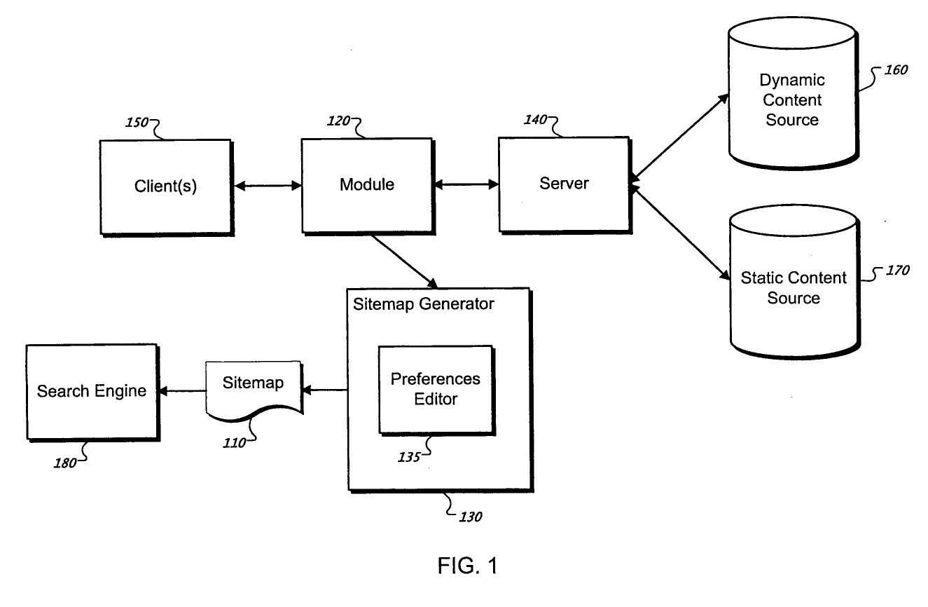

FIG. 1 is a block diagram illustrating an example of generation and submission of a sitemap 110. A module 120 is installed on a server 140 to scan Hypertext Transfer Protocol (HTTP) traffic between the server 140 and one or more clients 150 (e.g., web browsers). In some implementations, the module also or alternatively scans other types of network traffic (e.g., Wireless Application Protocol (WAP) traffic). The server 140 accepts resource request messages (e.g., HTTP requests) from the one or more clients 150, and serves resources (e.g., HTTP responses, web pages, images, or multimedia content) to the one or more clients 150 in response to the resource request messages. In some implementations, the server 140 is a web server. The web server can be one or more computers running a computer program such as Microsoft® Internet Information Services or Apache™ HTTP Server. In some implementations, the server 140 is a proxy server.

The HTTP traffic between the server 140 and the one or more clients 150 includes the resource request messages from the one or more clients 150 and the resources that are served by the server 140. In addition to data content that conventional web crawlers can typically crawl, the HTTP traffic can include data content that conventional web crawlers cannot typically crawl. The resources that are served by the server 140 can include data content from dynamic content sources 160. For example, the dynamic content sources 160 can include dynamic content that is created based on user input (e.g., search queries) or dynamic content that is generated from one or more databases. Conventional web crawlers cannot automatically provide input to generate and crawl dynamic content. The resources that are served by the server 140 can also include data content from static content sources 170. Conventional web crawlers cannot typically crawl static content that is not hyper-linked by crawled web pages.

However, the resources that are served by the server 140 can be identified by the module 120 by scanning the HTTP traffic between the server 140 and one or more clients 150. In some implementations, the module 120 is plug-in software installed in a web server program running on the server 140. In some alternative implementations, the module 120 is software installed in a network layer of the server 140.

The module 120 can extract data (e.g., URL information) from the HTTP traffic. The module 120 can include a filter that extracts the URL information from the resources that are served by the server 140. The module 120 can scan HTTP return codes in the HTTP responses. If an HTTP return code that indicates a successful request (e.g., HTTP return code 200 indicating that all requested information was returned) is scanned, the filter can extract URL information from the resources that are served by the server 140.

The URL information can include one or more URLs that identify the resources. The URL information can include the URL of a web page and URLs of images and other content that are included in the web page. In addition, the URL information can include other data corresponding to the URLs. For example, the URL information can include a last modified date (e.g., a last-modified header in an HTTP response) of the resource.

In some implementations, the filter is configured to extract URL information only for particular websites. The server 140 may serve resources for more than one website. The filter can be configured to extract URL information only for websites selected by a webmaster. Therefore, sitemaps will be automatically generated only for the selected websites.

The sitemap generator 130 can automatically generate the sitemap 110 from the URL information and store the sitemap 110 in a computer-readable memory. The sitemap generator 130 can also automatically notify the search engine 180 that the sitemap 110 has been generated or modified. A search engine may have a public URL (e.g., http://google.com/webmasters/sitemaps/ping?sitemap=) that allows webmasters to submit sitemaps. The sitemap generator 130 can send an HTTP request to the public URL to notify the search engine that the sitemap 110 has been generated or modified. Alternatively or in addition, the sitemap generator 130 can submit the sitemap 110 using a particular search engine's submission interface. Optionally, the sitemap generator can specify the location of the sitemap 110 in a robots.txt file. Additional details about ways of notifying search engines of the availability of a sitemap are described under the heading Sitemaps XML Format at http://www.sitemaps.org/protocol.php.

The sitemap generator 130 can include a preferences editor 135 that allows a webmaster to define webmaster preferences. By defining webmaster preferences, a webmaster can control how a sitemap is generated or how the sitemap generator 130 notifies the search engine 180 that the sitemap 110 has been generated or modified. In some implementations, the preferences editor presents a user interface including elements such as drop-down menus, radio buttons, check boxes, and text fields to allow the webmaster to define the webmaster preferences. In some implementations, the preferences editor is a document editor that allows the webmaster to edit the webmaster preferences in a document that stores the webmaster preferences.

In some implementations, the sitemap generator 130 automatically notifies the search engine 180 according to webmaster preferences. Thus, the sitemap generator 130 may notify the search engine 180 periodically (e.g., once a week, once a month), when the sitemap 110 reaches a certain size (e.g., a threshold number of URLs or file size), or when the sitemap 110 differs by a threshold amount (e.g., a number of URLs or a file size) from a previous sitemap for the website.

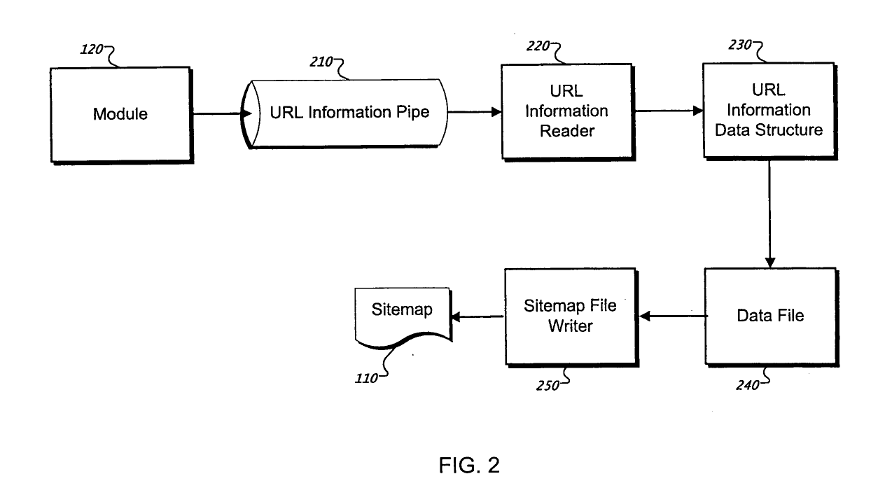

FIG. 2 is a block diagram illustrating an example of generation of a sitemap 110. In some implementations, the module 120 stores the URL information in a URL information pipe 210. The URL information pipe 210 can be implemented in shared global memory. A web browser can request a web page from a website. If the requested web page is successfully served to the web browser, the module 120 stores the web page's URL in the URL information pipe 210. The module 120 can also store URLs relating to images and other content that are included in the web page. In addition, the module 120 can store other data (e.g., a time the URL is scanned by the module 120) corresponding to the stored URLs.

In some implementations, the module 120 stores the URL information according to webmaster preferences. A webmaster can configure the module 120 to exclude some URL information from being stored in the URL information pipe 210. The webmaster can add particular URLs or URL patterns (e.g., http://secure/ . . . /*.htm) to an exclusion list, so that the module 120 does not store URL information for URLs that match entries in the exclusion list.

The sitemap generator 130 automatically generates a sitemap 110 from the URL information in the URL information pipe 210. In some implementations; the sitemap generator 130 includes a URL information reader 220 and a sitemap file writer 250.

The URL information reader 220 reads and processes the URL information in the URL information pipe 210 and generates a URL information data structure 230. The URL information data structure 230 can be a hash table. The hash table can be limited by a maximum number of URLs (e.g., 100,000 URLs) or a maximum memory size (e.g., 300 MB of disk space).

For each unique URL in the URL information pipe 210, the URL information reader 220 can create an entry in the URL information data structure 230 that includes, for example, the URL, a first time the URL was scanned by the module 120, and one or more counters. For multiple occurrences of a URL in the URL information pipe 210, the URL information reader 220 can increase a first counter that represents the number of times a resource identified by the URL was served successfully with new content (e.g., the resource that was requested has been modified since it was last requested). The URL information reader 220 can regard the resource as having been served successfully if the response included an HTTP return code 200 indicating that all requested information was returned. In addition, the URL information reader 220 can regard the resource as having with new content based on changes to file properties of the resource such as file time, length, or type.

In addition, the URL information reader 220 can increase a second counter that represents the number of times a URL was visited. For example, a URL was visited if a resource was requested and the response served by the server 140 does not indicate an error or failure. In particular, examples of HTTP return codes that represent that a URL was visited include HTTP return code 204 (the resource has no new content) and HTTP return code 304 (the resource has not been modified).

The contents of the URL information data structure 230 can be flushed to a data file 240. The size of the data file 240 can be limited in order to decrease total memory usage. The data file 240 can be limited to a maximum number of URLs (e.g., 1,000,000 URLs) or a maximum memory size (e.g., 300 MB of disk space).

In some implementations, the contents of the URL information data structure 230 is flushed to the data file 240 according to webmaster preferences. The contents of the URL information data structure 230 can be flushed to the data file 240 if the URL limit or memory limit of the URL information data structure 230 is reached, or according to a period of time (e.g., once a week).

Because the URL information data structure 230 can be periodically flushed to the data file 240, the data file 240 may include multiple entries for the same URLs. Therefore, the sitemap generator can scan the data file 240 for the multiple entries and merge the multiple entries. The sitemap generator can merge two entries for the same URL to create a single entry for the URL that includes the URL, a first time the URL was scanned by the module 120 (e.g., the earlier of the times recorded in the entries), and one or more counters (e.g., a sum of the respective counters in the entries).

The sitemap file writer 250 generated a sitemap 110 from URL information in the data file 240. In some implementations, sitemaps are generated that conform to the XML schema for the Sitemap protocol, defined at http://www.sitemap.org. In some implementations, sitemaps are generated according to other protocols, in particular, to protocols that extend the Sitemap protocol. The sitemap file writer 250 can use the data to generate news sitemaps, video sitemaps, code search sitemaps, and mobile sitemaps. In some implementations, sitemaps are generated according to other formats such as a syndication feed (e.g., Real Simple Syndication (RSS) feed) or a text file that includes a list of URLs.

In some implementations, the sitemap file writer 250 generates URL metadata to be included in the sitemap 110. For example, the URL metadata can include an observed frequency with which a resource identified by a URL changes and an inferred priority of the resource based on the frequency with which it is requested.

The observed frequency with which a resource identified by an ith URL in the data file 240, where i≧0, changes can be computed by subtracting the first time the ith URL was scanned by the module 120 (T(i)) from the current time (current_time), and dividing the difference by the number of times the resource has been served successfully with new content (C(i)). This computation can be represented by the equation:

$$change\_frequency ( i ) = \frac{current\_time - T ( i )}{C ( i )} ,$$

where i≧0. The frequencies that the URLs change can then be normalized according to a period of time (e.g., an hour, a day, a week, or a month).

The inferred priority of a resource identified by the ith URL in the data file 240 can be computed by dividing the logarithm of the number of times the ith URL was visited (D(i)) by the logarithm of the number of times all URLs were visited. This computation can be represented by the equation:

$$priority ( i ) = \frac{log [ D ( i ) ]}{log [ {\sum }_{j} D ( j ) ]} ,$$

where i≧0 and j is the number of URLs in the data file 240. The priorities can be normalized so that all the priorities fall within a range between zero and one (e.g., 0≦priority(i)≦1, for all i).

In some implementations, the sitemap generator 130 modifies the URL information according to webmaster preferences before automatically generating the sitemap. For example, the sitemap generator 130 can remove session identifiers or user identifiers from URLs extracted by a filter in the module 120.

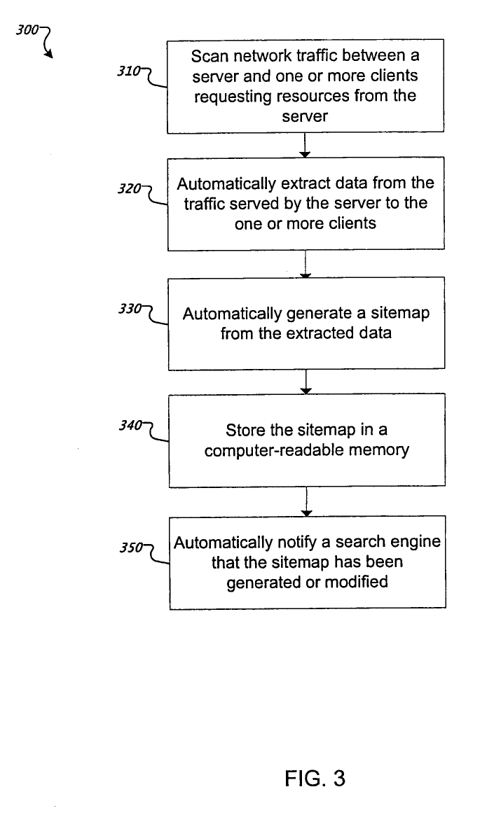

FIG. 3 is a flow chart showing an example process 300 for automatically generating a sitemap. Network traffic between a server and one or more clients requesting resources from the server is scanned 310. Data is automatically extracted 320 from the traffic served by the server to the one or more clients. A sitemap is automatically generated 330 from the extracted data, and the sitemap is stored 340 in a computer-readable memory. Optionally, a search engine is automatically notified 350 that the sitemap has been generated or modified.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
scanning network traffic between a server and one or more clients requesting resources from the server, the network traffic including resource request messages from the one or more clients and resources served by the server in response to the resource request messages;
automatically extracting data from the traffic served by the server to the one or more clients, the extracted data including one or more Uniform Resource Locators that identify the resources served by the server to the one or more clients;
automatically generating a sitemap from the extracted data; and
storing the sitemap in a computer-readable memory.

2. The method of claim 1, wherein the sitemap includes the one or more Uniform Resource Locators.

3. The method of claim 2, wherein the sitemap further includes at least one of:
a last modified date, a change frequency, or a priority for the one or more Uniform Resource Locators.

4. The method of claim 1, further comprising:
automatically notifying a search engine that the sitemap has been generated or modified.

5. The method of claim 1, further comprising:
according to webmaster preferences, modifying the extracted data before automatically generating the sitemap.

6. A system comprising:
a server comprising a computer; and
one or more clients in data communication with the server;
wherein the server performs the actions of:
scanning network traffic between the server and the one or more clients requesting resources from the server, the network traffic including resource request messages from the one or more clients and resources served by the server in response to the resource request messages;
automatically extracting data from the traffic served by the server to the one or more clients, the extracted data including one or more Uniform Resource Locators that identify the resources served by the server to the one or more clients;
automatically generating a sitemap from the extracted data; and
storing the sitemap in a computer-readable memory.

7. The system of claim 6, wherein the sitemap includes the one or more Uniform Resource Locators.

8. The system of claim 7, wherein the sitemap further includes at least one of:
a last modified date, a change frequency, or a priority for the one or more Uniform Resource Locators.

9. The system of claim 6, wherein the server further performs the action of automatically notifying a search engine that the sitemap has been generated or modified.

10. The system of claim 6, wherein the actions of scanning and extracting are performed by plug-in software installed in a web server program running on the server.

11. The system of claim 6, wherein the actions of scanning and extracting are performed by software installed in a network layer of the server.

12. A computer program product, stored on a computer-readable medium, comprising instructions that when executed on a server cause the server to perform operations comprising:
scanning network traffic between the server and one or more clients requesting resources from the server, the network traffic including resource request messages from the one or more clients and resources served by the server in response to the resource request messages;
automatically extracting data from the traffic served by the server to the one or more clients, the extracted data including one or more Uniform Resource Locators that identify the resources served by the server to the one or more clients;
automatically generating a sitemap from the extracted data; and
storing the sitemap in a computer-readable memory.

13. The product of claim 12, wherein the sitemap includes the one or more Uniform Resource Locators.

14. The product of claim 13, wherein the sitemap further includes at least one of:
a last modified date, a change frequency, or a priority for the one or more Uniform Resource Locators.

15. The product of claim 12, wherein the operations further comprise automatically notifying a search engine that the sitemap has been generated or modified.

16. The product of claim 12, wherein the product is configured as plug-in software to be installed in a web server program running on the server.

17. The product of claim 12, wherein the product is configured as plug-in software to be installed in a network layer of the server.
